(19) United States
(12) Patent Application Publication
(10) Pub. No.: US 2019/0070710 A1
(43) Pub. Date: Mar. 7, 2019

(54) METHOD FOR REUSING AN ABRASIVE TOOL

(71) Applicant: THYSSENKRUPP AG, Essen (DE)

(72) Inventors: Maximilian BÜTTNER, Sankt Gallen (CH); Frank CICHY, Dresden (DE)

(73) Assignee: THYSSENKRUPP AG, Essen (DE)

(21) Appl. No.: 16/084,601

(22) PCT Filed: Mar. 10, 2017
(86) PCT No.: PCT/EP2017/055668

§ 371 Date: Sep. 13, 2018

(30) Foreign Application Priority Data
Mar. 18, 2016 (DE) 10 2016 105 049.0

(51) Int. Cl. B24D 3/00; B24D 3/28; B24D 18/00; C09J 5/00; C09J 163/00

(52) U.S. Cl. CPC B24D 3/007; B24D 3/28; B24D 18/0072; C09J 2463/00; C09J 163/00; C09J 2205/302; C09J 5/00

(57) ABSTRACT

A method of recoating an abrasive tool, wherein the abrasive tool includes a main tool body, which has at least one accommodating surface for accommodating abrasive bodies, wherein the abrasive bodies are adhesively bonded to the accommodating surface by an adhesive. The method includes at least the following steps: degenerating the adhesive, detaching the worn-out abrasive bodies from the main tool body, detaching the degenerated adhesive from the main tool body, reapplying the adhesive; and recoating the main tool body with new abrasive bodies.

The invention relates to a method for recoating an abrasive tool, wherein the abrasive tool comprises a main tool body, which comprises at least one accommodating surface for accommodating abrasive bodies, wherein the abrasive bodies are adhesively bonded to the accommodating surface by means of an adhesive.

### PRIOR ART

DE 31 48 499 A1 discloses a method for recoating an abrasive tool, wherein the abrasive tool comprises a main tool body, which comprises at least one accommodating surface for accommodating abrasive bodies. The abrasive bodies are adhesively bonded to the accommodating surface by means of an adhesive and, if said abrasive bodies have been worn out and have to be changed over, then a releasable separating layer makes it possible to separate the abrasive bodies from the accommodating surface. In order to avoid adhesive residues adhering to the accommodating surface of the abrasive body, it is also specified that the separating layer should be applied to the accommodating surface of the abrasive body, it then being possible for the abrasive body, for example in the form of an abrasive strip, to be adhesively bonded to the separating layer. The connection between the abrasive bodies and the main tool body, however, is multilayered and thus work-intensive.

The prior art discloses abrasive tools having main tool bodies which are formed from a carbon-fiber-composite material, see DE 10 2015 122 233 A1. CFRP main bodies are used, in particular, on account of the low weight. Accordingly, for example CBN abrasive bodies are applied to the main tool body made of CFRP and, if worn-out abrasive bodies have to be removed, this is done by the abrasive bodies being chiseled away from the main body, which results in the main body being subjected to pronounced mechanical stressing. However, CFRP main bodies are distinguished, in particular, by tensile strength and stiffness and are, disadvantageously, sensitive to impact and shock. Consequently, the residues of the abrasive coating, and also of the adhesive, are removed from the main body by turning. It is inevitable here that carbon fibers are cut and damaged. In order to avoid failure of the main body, it is therefore necessary to incorporate so-called sacrificial layers in the outer layers of the main body. It is nevertheless possible for microcracks to form, these having an adverse effect on the structure and the use behavior of the CFRP main body.

The aim is therefore to simplify the operation of recoating abrasive tools, and main bodies produced from CFRP materials should be subjected to only minimal loading or damage, if any at all, it therefore being possible to achieve a considerable increase in the service life and in the recoating frequency.

### DISCLOSURE OF THE INVENTION

The object of the invention is to develop a method for recoating an abrasive tool in which it is possible for worn-out abrasive bodies to be removed in a manner which does not adversely affect the main tool body. In particular, the intention is for it to be possible for a main tool body of the abrasive tool to be reused as frequently as possible.

Proceeding from a method according to the preamble of claim 1, and proceeding from a recoatable abrasive tool according to the preamble of claim 8, this object is achieved by the characterizing features of each of said claims. Advantageous developments of the invention are specified in the dependent claims.

According to the invention, the method comprises at least the following steps: degenerating the adhesive; detaching the worn-out abrasive bodies from the main tool body; detaching the degenerated adhesive from the main tool body; reapplying the adhesive; and recoating the main tool body with new abrasive bodies.

The core idea of the invention is the use of a degenerative adhesive, and therefore the recoating method comprises the step of degenerating the adhesive, which, without any further additional layers being used, forms the connection between the abrasive bodies and the accommodating surface of the main tool body, it being possible for the connection to be released straightforwardly and gently when degeneration takes place. The solution according to the invention for implementing the method is very straightforward and cost-effective, and neither a user nor the material, in particular the main tool body, are put at risk for any length of time. The method renders the hitherto necessary sacrificial layers on the main tool body superfluous, and said layers are dispensed with. The main tool body, in particular formed from a CFRP material, is advantageously adapted, designed and cost-effectively produced.

The adhesive is particularly advantageously degenerated by heat being introduced into the adhesive. The heating, for example so that the main body is impaired as minimally as possible, is introduced from the outside, via the worn-out abrasive bodies, and therefore the heat reaches the adhesive in the adhesive joint between the abrasive bodies and the main tool body without heating the main tool body to any significant extent. However, it is also conceivable for the entire abrasive tool to be introduced into a furnace, and the adhesive is selected such that it degenerates at temperatures which are not high enough to cause impairment of the main tool body.

A further particular advantage is achieved if the adhesive is degenerated by an organic acid. Therefore, according to an advantageous variant, the method provides, as an alternative or in addition, for an organic acid to be brought into contact with the adhesive. The organic acid used is, for example, acetic acid, which is brought into contact with the adhesive. As the adhesive is dissolved by organic acid, in particular acetic acid, it is further advantageously made possible in the first instance for the worn-out abrasive bodies to be removed mechanically, the adhesive therefore being exposed. It is advantageously only then that the organic acid, that is to say in particular acetic acid, is brought into contact with the adhesive. If the adhesive is degenerated, in particular dissolved, then it can straightforwardly be removed from the accommodating surface without the main tool body being subjected, in particular, to mechanical loading.

A further advantage is achieved if the adhesive used is a two-component epoxy-adhesive system. In particular, the two-component epoxy-adhesive system is used as an amine-curing adhesive system. Such adhesive systems can be degenerated by heat and/or by contact with organic acid, and it is therefore possible for the method according to the invention to be implemented in particular with such adhesive systems.

The method for recoating an abrasive tool is suitable, in particular, for main tool bodies which comprise a CFRP main body, and the temperatures which are necessary in order to degenerate an adhesive by means of heat can be selected such that a CFRP main body is not impaired by the heat introduced. It is likewise particularly advantageous if acetic acid is used to degenerate the adhesive, since acetic acid does not attack a CFRP main body and/or does not give rise to any interaction with the material of a CFRP main body.

The invention is also directed to a recoatable abrasive tool having a main tool body and having abrasive bodies adhesively bonded to an accommodating surface of the main tool body. According to the invention, the abrasive bodies are adhesively bonded to the main tool body by an adhesive which can be degenerated by means of heat and/or by means of an organic acid. The adhesive advantageously comprises a two-component epoxy-adhesive system, and/or provision is made for the main tool body to comprise a CFRP material. The adhesive can be degenerated, in particular, by means of an acetic acid. Within the framework of the invention, in particular provision is made, for the purpose of degenerating the adhesive system, both for heat to be introduced and for the adhesive to be degenerated by means of an acetic acid. Subjecting the adhesive system to a two-pronged course of action here particularly allows the adhesive to be dissolved gently, without the CFRP material of the main tool body being impaired. This is particularly advantageous in that the recoatable abrasive tool comprises an adhesive which can be degenerated both by means of heat and by means of an acetic acid, and therefore both courses of action can be applied to the adhesive, in particular simultaneously.

### EXEMPLARY EMBODIMENT OF THE INVENTION

Further measures which improve the invention will be presented in more detail hereinbelow, together with the description of an exemplary embodiment of the invention, with reference to the figures, in which:

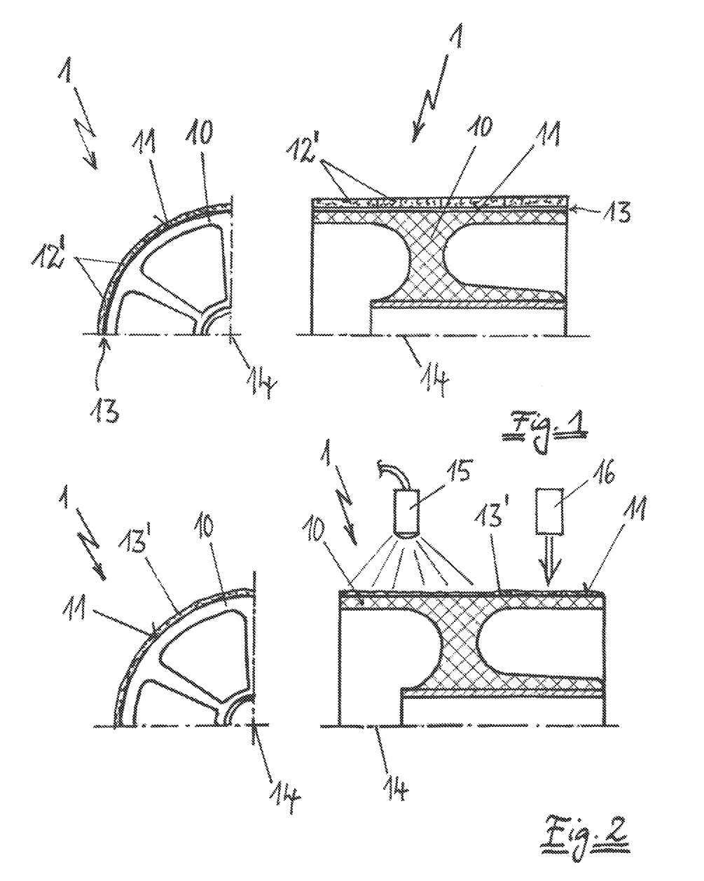

FIG. 1 shows the abrasive tool illustrated in the form of a half cross section and of a partial front view, wherein worn-out abrasive bodies are present on an accommodating surface of the abrasive tool,

FIG. 2 shows the abrasive tool according to FIG. 1, wherein the abrasive bodies have been removed and wherein the adhesive is being degenerated,

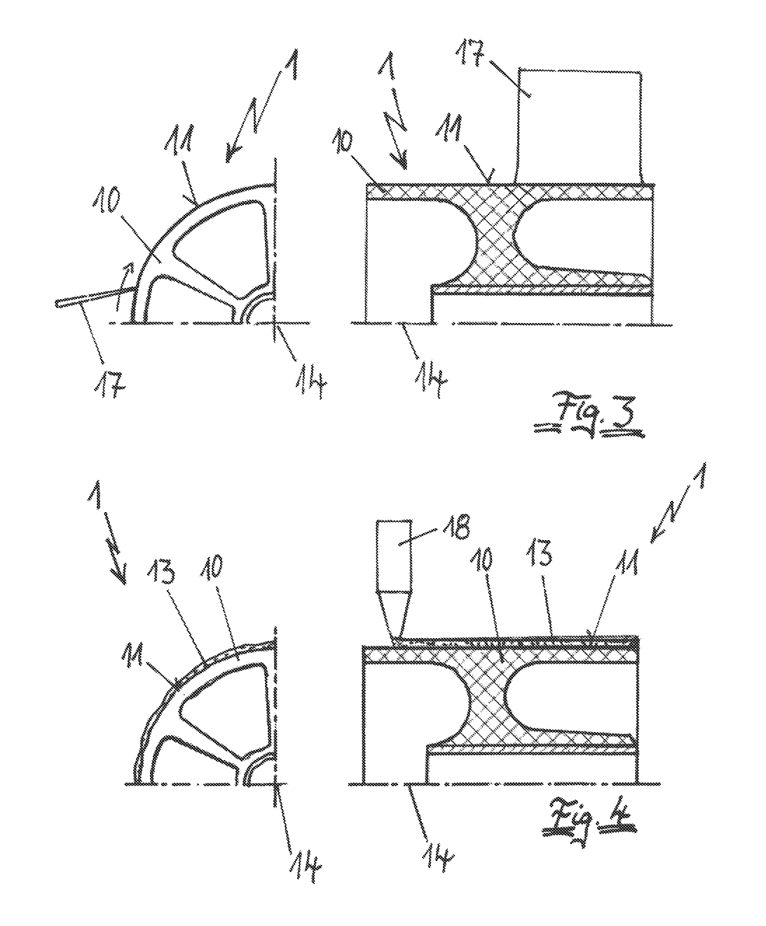

FIG. 3 shows the abrasive tool according to FIG. 2, wherein the adhesive is being removed mechanically from the accommodating surface,

FIG. 4 shows the abrasive tool with a new adhesive being applied to the accommodating surface,

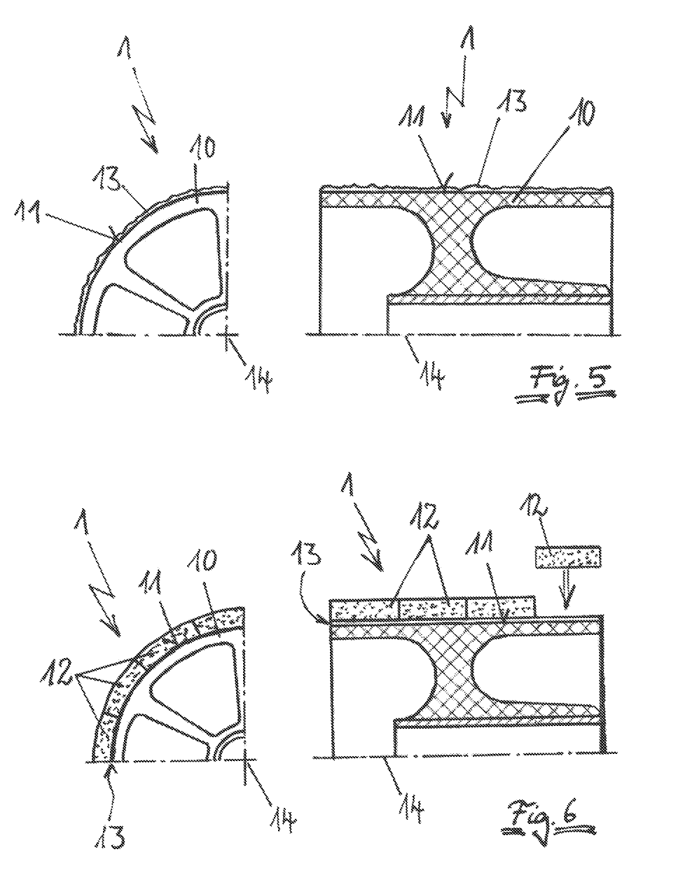

FIG. 5 shows the abrasive tool with a newly applied adhesive on the accommodating surface, and

FIG. 6 shows the abrasive tool onto which new abrasive bodies is being applied onto the accommodating surface wetted with adhesive.

FIGS. 1 to 6 each show an abrasive tool 1 in the form of a half cross section taken along a center axis 14 of a main tool body 10 and in the form of a left-hand front view, in which part of the circumference of the abrasive tool 1 is shown from the direction of the center axis 14. The main tool body 10 comprises an essentially cylindrical accommodating surface 11, to which a plurality of abrasive bodies 12 have been applied. The abrasive bodies 12 are secured by an adhesive 13, which is located in the adhesive joint between the accommodating surface 11 of the main tool body 10 and the used-up abrasive bodies 12.

FIG. 1 shows an abrasive tool 1 with worn-out abrasive bodies 12′, which, in order for the abrasive tool 1 to be recoated, have to be removed from the main tool body 10. In order for the adhesive 13 to be degenerated, it is possible, so that the adhesive 13 can be more easily reached, for the worn-out abrasive bodies 12′ to be removed first of all from the accommodating surface 11.

FIG. 2 shows the method according to the invention for degenerating the adhesive 13′, the invention using, for this purpose, for example an acid which is applied by means of a spray source 15. Also shown is a heat source 16, by means of which heat—shown by an arrow—is introduced into the layer of adhesive 13′ in order to degenerate the same. It is advantageous here if the degeneration of the adhesive 13 is preceded by the worn-out abrasive bodies 12′ being separated off mechanically, for example by being machined using turning or grinding.

FIG. 3 shows the abrasive tool 1 with the main tool body 10 and a detaching tool 17, by means of which the degenerated adhesive 13′ is removed mechanically from the accommodating surface 11, for example by being scraped off, in which case both the abrasive bodies 12′ and the adhesive 13′ have been removed from the accommodating surface 11.

FIG. 4 shows the step of a new adhesive 13 being applied to the accommodating surface 11 by means of an adhesive source 18. The adhesive 13 used is, for example, a two-component epoxy-adhesive system, and this therefore comprises particularly advantageous properties for repeated degeneration.

FIG. 5 shows the abrasive tool 1, the new adhesive 13 finally having been applied in full to the accommodating surface 11 of the main tool body 10.

FIG. 6 shows the method step in which new, intact abrasive bodies 12 are being adhesively bonded, the adhesive 13 serving for adhesive-bonding purposes.

The method for recoating the abrasive tool 1 can be repeated on a very frequent basis, since the degeneration of the adhesive 13 involves just a purely chemical process, without the main tool body 10 having to be subjected to any mechanical action. Even when the abrasive bodies 12 are being separated off in order to expose the adhesive 13, the main tool body 10 is not subjected to any mechanical loading.

The invention is not restricted to the preferred exemplary embodiment specified above. Rather, a number of variants which make use of the solution presented, even in respect of embodiments of fundamentally different kinds, are conceivable. All of the features and/or advantages which can be gathered from the claims, the description or the drawings, including design-related details or three-dimensional arrangements, may be essential to the invention both in their own right out also in a wide variety of combinations.

### LIST OF REFERENCE SIGNS

1 Abrasive tool

10 Main tool body

11 Accommodating surface

12 Abrasive body

12′ Worn-out abrasive body

13 Adhesive

13′ Degenerated adhesive

14 Center axis

15 Spray source

16 Heat source

17 Detaching tool

18 Adhesive source

1.-11. (canceled)

12. A method for recoating an abrasive tool, wherein the abrasive tool comprises a main tool body, which comprises at least one accommodating surface for accommodating abrasive bodies, wherein the abrasive bodies are adhesively bonded to the accommodating surface by means of an adhesive, wherein the method comprises:
degenerating the adhesive,
detaching, from the main tool body, the worn-out abrasive bodies,
detaching, from the main tool body, the degenerated adhesive,
reapplying the adhesive, and
recoating the main tool body with new abrasive bodies.

13. The method of claim 12, including introducing heat into the adhesive to degenerate the adhesive.

14. The method of claim 12, including bringing an organic acid into contact with the adhesive to degenerate the adhesive.

15. The method of claim 14, wherein the organic acid is acetic acid.

16. The method of claim 12, wherein the adhesive is a 2-component epoxy-adhesive system.

17. The method of claim 16, wherein the 2-component epoxy-adhesive system used is an amine-cured adhesive system.

18. The method of claim 12, wherein the main tool body provided is a CFRP main body.

19. A recoatable abrasive tool which is recoated according to the method of claim 12.

20. The recoatable abrasive tool of claim 19, wherein the abrasive bodies are adhesively bonded to the main tool body by an adhesive which can be degenerated at least by means of heat or by means of an organic acid.

21. The recoatable abrasive tool of claim 19, wherein the adhesive comprises at least one 2-component epoxy-adhesive system, or the main tool body comprises a CFRP material.

22. The recoatable abrasive tool of claim 19, wherein the adhesive is capable of being degenerated by means of an acetic acid.
